(19) United States
(12) Patent Application Publication
(10) Pub. No.: US 2019/0160424 A1
(43) Pub. Date: May 30, 2019

(54) VESSEL EXHAUST GAS DENITRATION SYSTEM AND METHOD OF DETERMINING NOZZLE CLOGGING IN THE SAME

(71) Applicant: PANASIA CO., LTD., Busan (KR)

(72) Inventors: Soo Tae LEE, Busan (KR); Su Kyu LEE, Busan (KR); Sang Kyu CHUN, Gimhae-si (KR); Kyung Chul JEONG, Busan (KR); Keun Jae YOOK, Changwon-si (KR)

(21) Appl. No.: 16/205,040

(22) Filed: Nov. 29, 2018

(30) Foreign Application Priority Data
Nov. 29, 2017 (KR) 10-2017-0161963

(51) Int. Cl. B01D 53/75; F01N 3/20; B01D 53/56; B01D 53/90; B01D 53/86; B01D 53/94

(52) U.S. Cl. CPC B01D 53/75; F01N 3/2066; B01D 53/56; B01D 53/90; B01D 2258/01; B01D 53/9431; F01N 2610/02; B01D 2251/2067; B01D 53/8625

(57) ABSTRACT

Provided are an exhaust gas vessel denitration system and a method of determining nozzle clogging in the same, and more particularly, an exhaust gas vessel denitration system including an exhaust pipe for discharging exhaust gas including nitrogen oxide generated from an engine of a vessel, a reducing agent inlet configured as an integrated dosing unit (IDU) for injecting a reducing agent into the exhaust pipe, and a reactor for inducing a reduction reaction of exhaust gas mixed with the reducing agent and decomposing nitrogen oxide in the exhaust gas to nitrogen and water vapor to reduce the nitrogen oxide, and a method of determining clogging of urea spray at an injector nozzle of the system.

### CROSS-REFERENCE TO RELATED APPLICATIONS

This application claims priority under 35 U.S.C. § 119 to Korean Patent Application No. 10-2017-0161963, filed on Nov. 29, 2017, in the Korean Intellectual Property Office, the disclosure of which is incorporated herein by reference in its entirety.

### TECHNICAL FIELD

The following disclosure relates to an exhaust gas vessel denitration system and a method of determining nozzle clogging in the same.

### BACKGROUND

Recently, internationally, regulations for environmental pollution have become stricter, and new conventions have been enacted and adopted to regulate the emission of air pollutants from ships.

International Maritime Organization (IMO) amends the Marine Pollution Treaty (MARPOL IV)' to propose tighter nitrogen oxide (NOx) regulations on discharge (Tier III) in the 62^{nd} Marine Environment Protection Committee (MEPC) in July, 2011 and effectuates the regulations on Jan. 1, 2016.

Accordingly, exhaust gas denitration equipment needs to be installed in an engine of a newly constructed vessel to permit the vessel to sail in the Emission Control Area (ECA). Thus, an exhaust gas vessel denitration system is essential for a vessel.

### SUMMARY

An embodiment of the present disclosure is directed to providing an exhaust gas vessel denitration system and a method of determining nozzle clogging in the same, for simplifying a structure of an exhaust gas vessel denitration system of a vessel using selective catalyst reduction (SCR) and reducing an installation space in the vessel. More particularly, the present disclosure is directed to an exhaust gas vessel denitration system including an exhaust pipe for discharging exhaust gas including nitrogen oxide generated from an engine of a vessel, a reducing agent inlet configured as an integrated dosing unit (IDU) for injecting a reducing agent into the exhaust pipe, and a reactor for inducing a reduction reaction of exhaust gas mixed with the reducing agent and decomposing nitrogen oxide in the exhaust gas to nitrogen and water vapor to reduce nitrogen oxide, and a method of determining clogging of urea spray at an injector nozzle of the system.

Another embodiment of the present disclosure is directed to providing an exhaust gas vessel denitration system and a method of determining nozzle clogging in the same, for simply omitting components such as a flow rate control valve and various gages accompanied thereby and controlling effective urea spray by forming a reducing agent inlet for injecting a reducing agent as an integrated dosing unit (IDU) formed by integrating a pump for supplying urea via control of a rotation number and an injecting module using pulse spray.

Another embodiment of the present disclosure is directed to providing an exhaust gas vessel denitration system and a method of determining nozzle clogging in the same, for supplying and spraying a fixed amount of urea and rapidly and accurately determining whether a nozzle clogs by periodically controlling a pump rotation number and opening and closing of a pulse injector.

Another embodiment of the present disclosure is directed to providing an exhaust gas vessel denitration system and a method of determining nozzle clogging in the same, for cooling a pulse injector included in an injecting module of a reducing agent inlet by compressed air to prevent the injecting module from being damaged by heat during heating of the compressed air.

Another embodiment of the present disclosure is directed to providing an exhaust gas vessel denitration system including a catalyst, which is capable of being miniaturized to ensure economic efficiency through a high specific surface area while maintaining advantages of a metallic catalyst, such as high strength and durability and excellent conductivity, and a method of determining nozzle clogging in the system.

Another embodiment of the present disclosure is directed to providing an exhaust gas vessel denitration system and a method of determining nozzle clogging in the same, for reducing a thickness and size of a catalyst and a size of a reactor through a high-efficiency catalyst including a support formed of metal with a surface on which a titanium oxide (TiO₂) nanotube is formed, and a reactive metal layer including one or more of vanadium (V) and tungsten (W) and supported on the support, to flexibly apply equipment for removing soot, and to integrally transfer the catalyst and the reactor during construction of the system.

Another embodiment of the present disclosure is directed to providing an exhaust gas vessel denitration system and a method of determining nozzle clogging in the same, for supporting a reactive metal layer on a support formed of metal with a surface on which a titanium oxide (TiO₂) nanotube is formed, using an atomic layer deposition (ALD) method to achieve high efficiency through a catalyst with a substantially maximized specific surface area.

It is to be understood that both the foregoing general description and the following detailed description of the present disclosure are explanatory and are intended to provide further explanation of embodiments of the invention as claimed.

In one general aspect, an exhaust gas vessel denitration system includes an exhaust pipe for discharging exhaust gas including nitrogen oxide generated from an engine, an urea tank for storing urea, an injecting module including a pulse type injector for mixing the urea with heated air to generate a reducing agent and spraying the reducing agent to the exhaust pipe according to a pulse signal, a rotation number adjusting-type pump for supplying the urea stored in the urea tank to the injecting module and connected to the injecting module to be operatively associated to the injecting module to control a supply amount of the reducing agent, a reducing agent inlet including a pressure transmitter for monitoring pressure of the reducing agent between the injecting module and the pump, a reactor for inducing a reduction reaction of exhaust gas mixed with the reducing agent and decomposing nitrogen oxide in the exhaust gas to nitrogen and water vapor to reduce the nitrogen oxide, wherein the reducing agent inlet is configured in such a way that the injecting module, the pump, and the pressure transmitter are formed as a module in an integrated dosing unit (IDU) that is one physical space.

The injecting module may include a chamber in which an outlet connected to the exhaust pipe and urea is sprayed from the injector, and a compressed air heating supply device for heating compressed air and introducing the compressed heated air into the chamber, wherein the urea is mixed with the compressed heated air in the chamber and is changed to ammonia.

The compressed air heating supply device may include a compressed air inlet for injecting the compressed air, a compressed air transfer pipe for transferring the compressed air injected through the compressed air inlet and introducing the compressed air into the chamber, and a heating unit for heating the compressed air inside the compressed air transfer pipe.

The compressed air transfer pipe may include a cooling part that is a section disposed adjacently to the injector and cools the injector by the compressed air prior to heating, and a heating part that is disposed adjacent to the heating unit next to the cooling part to heat and transfer the compressed air transmitted through the cooling part and to introduce the compressed air into the chamber.

The cooling part may be formed to surround the injector.

The heating unit may be a heater disposed inside or outside the heating part.

The reactor may include a catalyst for inducing a reduction reaction of exhaust gas mixed with ammonia, and a reactor with the catalyst positioned therein.

The catalyst may include a support formed of metal with a surface on which a titanium oxide (TiO₂) nanotube is formed, and a reactive metal layer including one or more of vanadium (V) and tungsten (W) and supported on the support.

The support may be formed of the metal that is titanium (Ti).

The titanium oxide (TiO₂) nanotube may have a diameter of 100 to 200 nm and a length of 300 nm to 1 μm.

The support may have a thickness of 0.1 to 0.15 mm.

The support may be changed to an anatase phase via thermal treatment.

The reactive metal layer may be supported on the support using an atomic layer deposition (ALD) method.

In another general aspect, a method of determining nozzle clogging in an exhaust gas vessel denitration system includes a) pre-drive operation for generating and maintaining appropriate pressure prior to an engine operation and urea spray, b) operation of determining whether an exhaust gas temperature condition for enabling SCR is satisfied, c) operation of selecting an urea dosing amount depending on a current engine load by a controller, d) operation of controlling opening and closing of an injector value to perform spray under PWM control, e) operation of controlling a rotation number of a dosing pump to maintain pressure of normal driving, and f) operation of checking a relationship between an urea spray amount and a pump rotation number.

### BRIEF DESCRIPTION OF THE DRAWINGS

FIG. 1 is a diagram showing an exhaust gas vessel denitration system according to an embodiment of the present disclosure.

FIG. 2 is a diagram showing a concept of an integrated dosing unit (IDU) included in an exhaust gas vessel denitration system according to an embodiment of the present disclosure.

FIG. 3 is a diagram showing a configuration of an injecting module included in an exhaust gas vessel denitration system according to an embodiment of the present disclosure.

FIG. 4 is a diagram showing a configuration of a reactor included in an exhaust gas vessel denitration system according to an embodiment of the present disclosure.

FIG. 5 is a cross-sectional view of a support of a catalyst.

FIGS. 6A and 6B are cross-sectional views of cases in which a reactive metal layer is formed on a surface of an example of a catalyst formed of metal and a surface of a catalyst formed of metal according to the present disclosure.

FIG. 7 is a flowchart showing a method of detecting nozzle clogging using an integrated dosing unit (IDU) according to an embodiment of the present disclosure

### DETAILED DESCRIPTION OF EMBODIMENTS

Hereinafter, an exhaust gas vessel denitration system according to the present disclosure is described in detail with reference to the accompanying drawings.

In an exhaust gas vessel denitration system, selective catalyst reduction (SCR) may be used. Selective catalyst reduction (SCR) refers a representative denitration technology for reduction of nitrogen oxide using a catalyst (platinum (Pt)-based catalyst, V₂O₅, Al₂O₃, TiO₂, Fe₂O₃, Cr₂O₃, or the like), that is, a method of reducing nitrogen oxide with nitrogen (N₂) and water (H₂O) using ammonia (NH₃) as a reducing agent. An exhaust gas vessel denitration system using selective catalyst reduction (SCR) includes an urea dosing portion and a reactor and, in this case, the urea dosing portion sprays urea to exhaust gas discharged from an engine to induce vaporization and to convert urea into ammonia, and the reactor facilitates an active reduction reaction with a catalyst positioned in the reactor using ammonia as a reducing agent.

In the foregoing exhaust gas vessel denitration system using selective catalyst reduction (SCR), the urea dosing portion induces vaporization of urea in a state in which urea is sprayed to exhaust gas and, in the case of a vessel, since engine exhaust gas has a low temperature of 180 to 210° C., the urea dosing portion of the exhaust gas vessel denitration system installed in the vessel includes a vaporizer, a burner, or the like to ensure temperature equal to or greater than 300° C., which is for vaporization and, thus, the configuration of the vessel is complicated and equipment is increased in size. An exhaust gas vessel denitration system of a vessel may be configured in such a way that an independent dosing module is installed for every exhaust pipe of each engine when a plurality of engines are present in the vessel, and this configuration causes inefficiency in terms of system management such as excessive spray of urea as well as an insufficient installation space.

A catalyst prepared by mixing reactive metal such as titanium oxide (TiO₂), vanadium (V), and tungsten (W) with ceramic and sintering the mixture in the form of a honeycomb is mainly used as a catalyst positioned in the reactor, and since this type of catalyst has low physical strength and durability, is vulnerable to moisture, and has high thermal conductivity, a significant time is taken to reach an active temperature.

In this situation, a catalyst needs to be prepared to be thick to ensure the strength and durability of the catalyst and, thus, a specific surface area of the catalyst is lowered and reactive metal present in the catalyst instead of a surface of the catalyst is not capable of exhibiting an original function thereof. As a result, the size of the catalyst needs to be increased to ensure a specific surface area and, thus, a size of the reactor is also increased to a level of 30 to 50% of a size of an engine. The reactor is vulnerable to vibration due to low strength and, thus, there is a limit in that a technology with low vibration needs to be applied to equipment for removing soot and that a catalyst needs to be separately moved during construction. Although a catalyst formed of a metal material that has excellent strength and durability and also has excellent thermal conductivity is present, the catalyst is expensive and, thus, economic efficiency may be too low to be applied to large-size transportation such as a vessel.

In this situation, according to the current trends, there has been a need to develop technologies for enhancing a structure of an urea inlet by reducing an installation space in a vessel of an exhaust gas vessel denitration system of a vessel using selective catalyst reduction (SCR) and simplifying a structure of the vessel and to enhance efficiency of a catalyst positioned in the reactor.

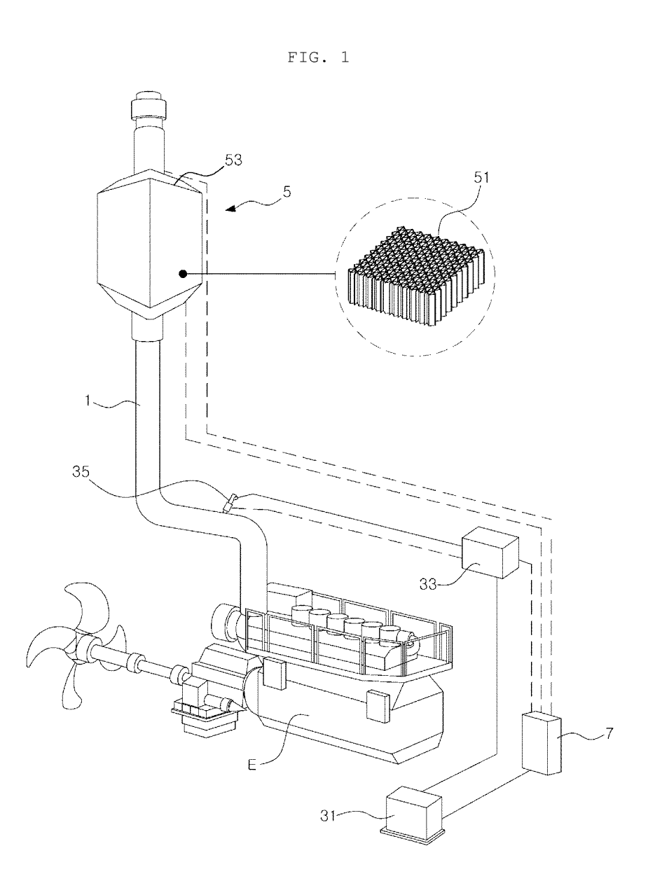

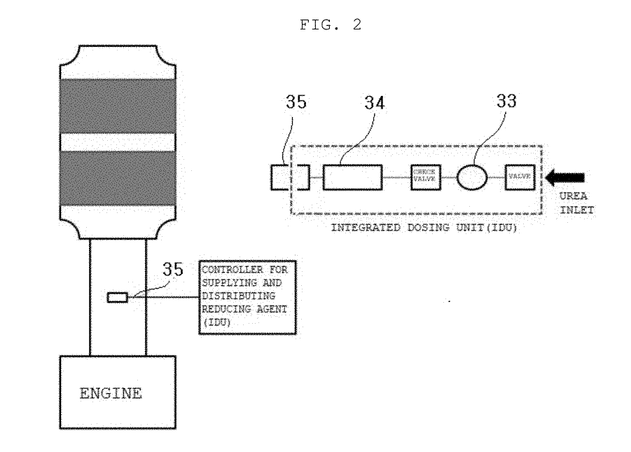

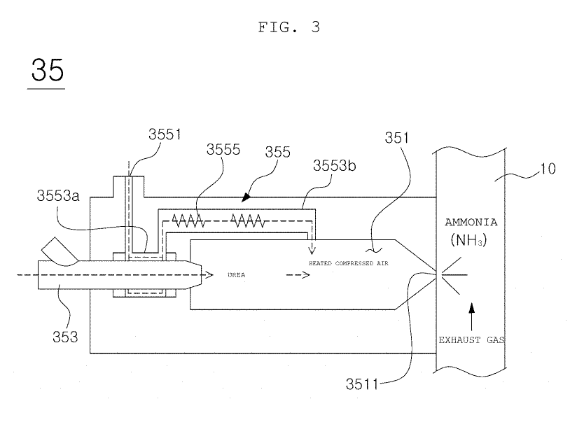

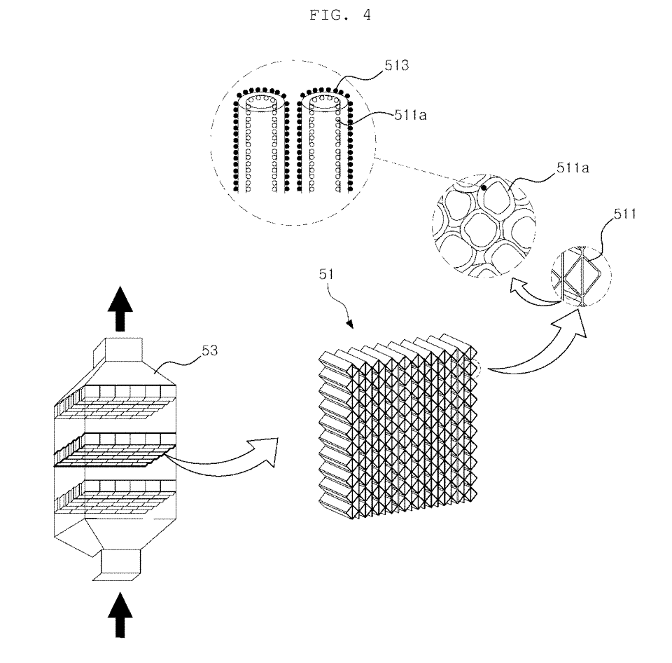

FIG. 1 is a diagram showing an exhaust gas vessel denitration system according to an embodiment of the present disclosure. FIG. 2 is a diagram showing a concept of an integrated dosing unit (IDU) included in an exhaust gas vessel denitration system according to an embodiment of the present disclosure. FIG. 3 is a diagram showing a configuration of an injecting module included in an exhaust gas vessel denitration system according to an embodiment of the present disclosure. FIG. 4 is a diagram showing a configuration of a reactor included in an exhaust gas vessel denitration system according to an embodiment of the present disclosure.

Referring to FIGS. 1 to 4, the exhaust gas vessel denitration system according to an embodiment of the present disclosure may be an exhaust gas vessel denitration system of a vessel using selective catalyst reduction (SCR) and may broadly include an exhaust pipe 1, a reducing agent inlet and a reactor 5.

The exhaust pipe 1 may be a path for discharging exhaust gas including nitrogen oxide generated in an engine E of a vessel and, in this regard, exhaust gas may be moved to the reactor 5 through the exhaust pipe 1 and may be mixed with ammonia injected into the exhaust pipe 1 by the reducing agent inlet before reaching to the reactor 5.

In this case, when a plurality of engines are present in the vessel, the exhaust pipe 1 may be installed for every engine.

The reducing agent inlet may inject a reducing agent into the exhaust pipe 1 and the reducing agent according to the present disclosure may be ammonia obtained via vaporization of urea.

The reducing agent inlet may broadly include an urea tank 31, an injecting module 35, a pump 33, and a pressure transmitter 34.

The urea tank 31 may store urea and, in this case, selective catalyst reduction (SCR) refers to a reaction for reduction of nitrogen oxide to nitrogen (N₂) and water (H₂O) using a catalyst (platinum (Pt)-based catalyst, V₂O₅, Al₂O₃, TiO₂, Fe₂O₃, Cr₂O₃, or the like) and may use ammonia (NH₃) as a reducing agent.

According to the present disclosure, the urea may be converted into ammonia and may enter the reactor and, in this case, the urea tank 31 may store urea to be converted into a reducing agent.

The injecting module 35 may include a pulse type injector 353 for mixing urea with heated air to generate a reducing agent and spraying the reducing agent to the exhaust pipe 1 according to a pulse signal.

The pump 33 may include a rotation number adjusting-type pump for pumping urea stored in an urea tank and supplying the urea to the injecting module 35 and connected to the injecting module 35 to be operatively associated with control of a supply amount of the reducing agent.

The pressure transmitter 34 may be configured to monitor pressure of a reducing agent supplied between the injecting module 35 and the pump 33, may measure pressure of urea, and may receive measurement information of the measured pressure.

In this case, the reducing agent inlet may include the injecting module 35, the pump 33, and the pressure transmitter 34, which are formed as one module in an integrated dosing unit (IDU) as one physical space.

That is, the reducing agent inlet may be configured in such a way that a manual valve, the pump 33, a check valve, the pressure transmitter 34, and the injecting module 35 are integrally configured as a compact integrated dosing unit (IDU), but not a method in which the pump 33 and the injecting module are separately configured to perform continuous injection using a throttle valve and, thus, supply and distribution of urea as a reducing agent may be effectively controlled.

In more detail, the integrated dosing unit (IDU) may receive a control signal from a PLC on a separate control board to control a rotation number of the pump 33 and may continuously supply urea to the injecting module 35 and, in this case, the pulse type injector 353 of the injecting module 35 may supply urea in a fixed amount via a periodic opening and closing operation of a nozzle according to a pulse signal.

As described above, the integrated dosing unit (IDU) may be formed in one physical space and, in this case, one physical space is a concept that a certain unit is stacked and installed on a plate structure, is installed in a three-dimensional structure with a predetermined volume, or is collectively installed in a fluid connectable region, or includes one connector for wired and wireless communication between constituent urea elements.

The integrated dosing unit (IDU) according to the present disclosure may control a rotation number of the pump 33 to continuously supply urea and, thus, may be a concept that a rotation number of the pump 33 is adjusted to supply urea in a fixed amount corresponding to a required amount, differently from a typical pressurization method.

In addition to the method of controlling the rotation number of the pump 33, the injector may periodically control a pulse type opening and closing operation to spray an urea in a fixed amount from a nozzle.

However, an urea return line may also be used in consideration of the case in which it is difficult to predict a sprayed quantity of urea or urea is not capable of being normally sprayed due to nozzle clogging or other causes.

The injecting module 35 may mix urea supplied by the pump 33 with heated air to generate ammonia and may spray the mixture to the exhaust pipe 1 and may include a chamber 351 and a compressed air heating supply device 355 as well as the aforementioned injector 353.

The chamber 351 is a space in which an outlet 3511 is connected to the exhaust pipe 1 and a process of mixing urea with compressed heated air to vaporize the urea to ammonia.

The outlet 3511 may be formed as a small hole compared with the chamber 351 and, since the compressed heated air and the urea are continuously supplied into the chamber 351, ammonia generated in the chamber 351 may be continuously injected to the exhaust pipe 1 by internal pressure.

The compressed air heating supply device 355 may heat compressed air to introduce the compressed air into the chamber 351.

The compressed heated air may vaporize urea injected into the chamber 351 to ammonia by the pulse type injector 353, and the compressed air heating supply device 355 may include a compressed air inlet 3551, a compressed air transfer pipe and a heating unit 3555.

The compressed air inlet 3551 may provide a path for injecting compressed air.

The compressed air transfer pipe may transfer compressed air injected through the compressed air inlet 3551 to introduce the compressed air into the chamber 351.

The compressed air transfer pipe may include a cooling part 3553a that is a section disposed adjacently to the pulse type injector 353 and cools the pulse type injector 353 by the compressed air prior to heating, and a heating part 3553b that is disposed adjacent to the heating unit 3555 next to the cooling part 3553a to heat and transfer the compressed air transmitted through the cooling part 3553a and to introduce the compressed air into the chamber 351.

The pulse type injector 353 includes a plastic material and, thus, may be damaged by heat and, in this regard, the compressed air transfer pipe 3553 may be arranged as described above to prevent the damage, and the compressed air may be intensively heated immediately prior to entrance into the chamber 351, thereby enhancing heating efficiency. The cooling part 3553a may be formed to surround the pulse type injector 353 for effective cooling and, to this end, a dual-pipe structure may be used.

The heating unit 3555 may heat compressed air inside the compressed air transfer pipe 3553.

The heating unit 3555 may include a heater disposed inside or outside the heating part 3553b.

To vaporize urea to ammonia, it may be to heat the compressed air at a temperature equal to or greater than 300 to 350° C., and the heating unit 3555 for effective heating may include two line heaters to surround opposite sides of the heating part 3553b.

The reactor 5 may induce a reduction reaction of exhaust gas mixed with ammonia to decompose nitrogen oxide in the exhaust gas to nitrogen and water vapor to reduce nitrogen oxide and may include a catalyst 51 and a reactor 53.

The catalyst 51 may induce a reduction reaction of exhaust gas mixed with ammonia.

The catalyst 51 may include a support 511 and a reactive metal layer 513.

The support 511 may be formed of metal with a surface on which a titanium oxide (TiO₂) nanotube is formed and the metal may include titanium (Ti).

The support may be formed by growing a titanium oxide (TiO₂) nanotube on a titanium plate via an anodic oxidation scheme using an electrolyte with a specific component such as ethylene glycol or HF, performing thermal treatment, and changing the titanium oxide (TiO₂) nanotube in an amorphous state to an anatase crystalline structure as a crystalline structure with excellent reactivity.

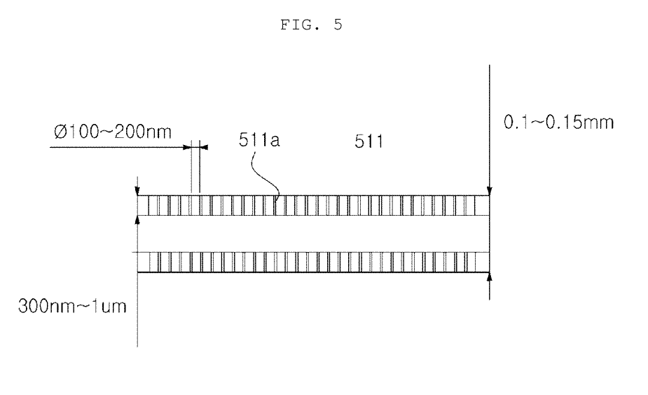

Referring to FIG. 5, as seen from a sectional view of the support 511, the support 511 may have a thickness of 0.1 to 0.15 mm and a titanium oxide (TiO₂) nanotube 511a may have a diameter of 100 to 200 nm and a length of 300 nm to 1 μm. Considering that a honeycomb-type catalyst formed of a ceramic material has a thickness of a sectional view of about 0.3 to 0.4 mm, the catalyst 51 may be small by 50% or greater compared with the foregoing honeycomb-type catalyst. Since both inner and outer portions of the titanium oxide (TiO₂) nanotube 511a are a contact surface of exhaust gas and ammonia, a specific surface area is also very large compared with a typical catalyst, which may ensure surface flow velocity of about 60,000 that is 6 times greater than 8,000 to 10,000 that is average surface flow velocity of an example of a catalyst.

The reactive metal layer 513 may be a component that includes one or more of vanadium (V) and tungsten (W) and is supported on the support 511. The reactive metal layer 513 may include metals with catalytic activity such as vanadium (V) and tungsten (W) in the form of V₂O₅ with catalytic activity, may be supported on the support 511, and may be coated on a surface of the support 511, including a surface of the titanium oxide (TiO₂) nanotube 511a of the support 511.

The reactive metal layer 513 may be coated on the support 511 using an atomic layer deposition (ALD) method.

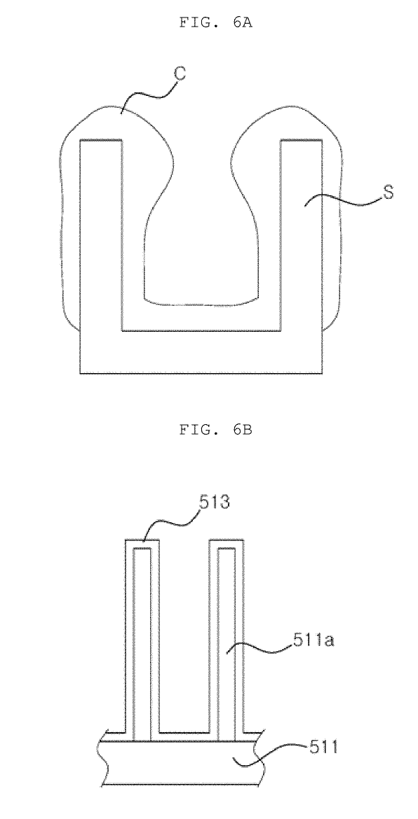

The catalyst illustrated in FIG. 6A is formed of a metal material and may be formed by coating a reactive metal layer on a surface of the support using a wash coat method. The wash coat method is difficult in terms of precise control and, thus, as shown in FIG. 6A, a reactive metal layer C is non-uniformly coated on a surface air void S of a support during preparation of the foregoing catalyst formed of a metal material.

When the reactive metal layer 513 is coated on the support 511 using a wash coat method, the titanium oxide (TiO₂) nanotube 511a has a very small diameter compared with an air void S of a support formed of a metal material and, thus, the titanium oxide (TiO₂) nanotube 511a may clog by the reactive metal layer 513 and an effect of increasing a specific surface area through the titanium oxide (TiO₂) nanotube 511a is barely achieved.

To prevent this, an atomic layer deposition (ALD) method of precisely thin-film supporting a reactive metal in units of atomic layers may be used and, as such, as shown in FIG. 6B, the reactive metal layer 513 may be formed to maintain all surface areas of the titanium oxide (TiO₂) nanotube 511a.

The reactor 53 may be a space in which the catalyst 51 is positioned and may be a portion for a reduction reaction in which nitrogen oxide in exhaust gas being in contact with the catalyst 51 is changed to nitrogen and water using ammonia as a reducing agent.

As described above, the catalyst 51 is a high-efficiency catalyst having a very large specific surface area and a small thickness and, thus, may be capable of being miniaturized.

The catalyst 51 may be formed of a metal material and may have properties of high strength and durability and of being resistant to moisture. Accordingly, according to the present disclosure, the size of the reactor 53 may be reduced, the catalyst 51 may be integrally moved and installed with the reactor 53 during a construction procedure of a system, and it may be possible to use equipment that generates vibration and, thus, equipment for removing soot, to be installed inside and outside the reactor 53, may be flexibly applied.

In addition, the exhaust gas vessel denitration system according to the present disclosure may further include a controller 7.

The controller 7 may control a system including the reducing agent inlet 3 and the reactor 5.

The controller may be a generally called control panel in automation equipment.

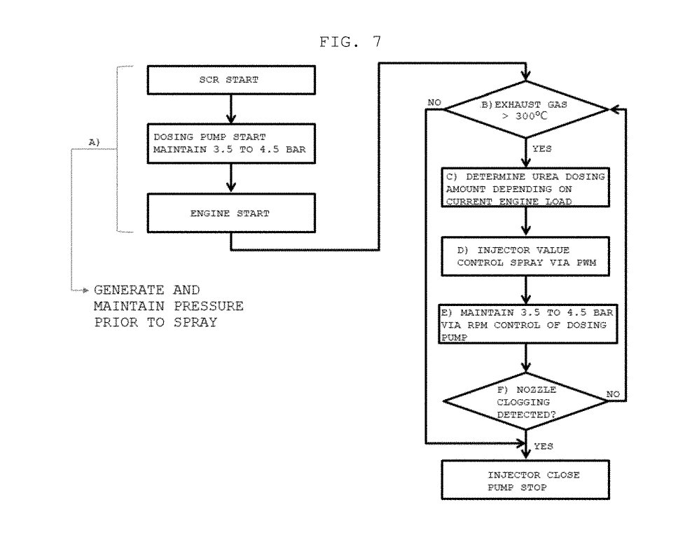

FIG. 7 is a flowchart showing a method of detecting nozzle clogging using an integrated dosing unit (IDU) according to an embodiment of the present disclosure. Operation a) may be a pre-drive operation of generating and maintaining appropriate pressure prior to an engine operation and urea spray. Operation b) may be an operation of determining whether an exhaust gas temperature condition for enabling SCR is satisfied. When temperature of exhaust gas is greater than about 300° C., the controller may select an urea dosing amount depending on a current engine load in operation c), and may control opening and closing of an injector valve to perform spray under PWM control in operation d). In this case, to continuously maintain an appropriate urea injection amount, a rotation number of a pump may be controlled to maintain pressure of a normal driving operation in operation e). During an operation of the system according to the present disclosure, a relationship between an urea spray amount and a rotation number of a pump may be checked to determine whether a nozzle clogs. In more detail, according to the present disclosure, whether a nozzle clogs may be determined in consideration of the following mathematical expression.

Rp1<Rp2 (Mathematical Expression 1)

Here, Rp1 is a pump rotation number when a nozzle clogs and Rp2 is a pump rotation number during normal driving.

In the case of normal driving without nozzle clogging after a nozzle is open to spray urea, when an urea spray amount is increased, pressure at a front end portion of the nozzle from which urea escapes may be remarkably reduced and, to compensate for this, a pump rotation number may be automatically increased to maintain an appropriate pressure by a preset program of the controller.

When the nozzle clogs, the pump rotation number is not changed, neither. For example, assuming that a required pressure condition of the nozzle is 3 bar and a pump rotation number for maintaining pressure is 100 when the nozzle completely clogs and that an automatically increased pump rotation number for maintaining pressure is 200 when a normal flow rate is 5 LPM, the nozzle is operated in a condition for spray of 5 LPM when the nozzle clogs but a pump rotation number may be maintained in 100 RPM. On the other hand, when the nozzle is operated in a condition for spray of 5 LPM during a normal operation, the pump rotation number may be 200 RPM. Accordingly, pump rotation number values in the case of nozzle clogging and an normal operation are 100 and 200, respectively and, thus, a relational expression of 100<200 may be satisfied. Accordingly, according to the present disclosure, a relationship between a spray amount condition at a nozzle and a pump rotation number may be simply monitored at any time point and, thus, a degree of nozzle clogging may be determined.

According to the present disclosure, the exhaust gas vessel denitration system according to the present disclosure may advantageously simplify a structure of an exhaust gas vessel denitration system of a vessel using selective catalyst reduction (SCR) and reduce an installation space in the vessel.

The exhaust gas vessel denitration system according to the present disclosure may be configured in such a way that a reducing agent inlet for injecting a reducing agent as an integrated dosing unit (IDU) formed by integrating a pump for supplying urea via control of a rotation number and an injecting module using pulse spray and, thus, it may be advantageous that components such as a flow rate control valve and various gages accompanied thereby are simply omitted and urea spray is effectively controlled.

The exhaust gas vessel denitration system according to the present disclosure may be advantageous to supply and spray a fixed amount of urea and to rapidly and accurately determine whether a nozzle clogs by periodically controlling a pump rotation number and opening and closing of a pulse injector.

The exhaust gas vessel denitration system according to the present disclosure may be advantageous to reduce a thickness and size of a catalyst and a size of a reactor through a high-efficiency catalyst including a support formed of metal with a surface on which a titanium oxide (TiO₂) nanotube is formed, and a reactive metal layer including one or more of vanadium (V) and tungsten (W) and supported on the support, to flexibly apply equipment for removing soot, and to integrally transferring the catalyst and the reactor during construction of the system.

The exhaust gas vessel denitration system according to the present disclosure may be configured in such a way that a reactive metal layer is supported on a support formed of metal with a surface on which a titanium oxide (TiO₂) nanotube is formed, using an atomic layer deposition (ALD) method and, thus, may be advantageous to achieve high efficiency through a catalyst with a substantially maximized specific surface area.

Accordingly, it will be obvious to those skilled in the art to which the present disclosure pertains that the present disclosure described above is not limited to the above-mentioned embodiments and the accompanying drawings, but may be variously substituted, modified, and altered without departing from the scope and spirit of the present disclosure.

What is claimed is:

1. An exhaust gas vessel denitration system, comprising:
an exhaust pipe for discharging exhaust gas including nitrogen oxide generated from an engine;
an urea tank for storing urea;
an injecting module including a pulse type injector for mixing the urea with heated air to generate a reducing agent and spraying the reducing agent to the exhaust pipe according to a pulse signal;
a rotation number adjusting-type pump for supplying the urea stored in the urea tank to the injecting module and connected to the injecting module to be operatively associated to the injecting module to control a supply amount of the reducing agent;
a reducing agent inlet including a pressure transmitter for monitoring pressure of the reducing agent between the injecting module and the pump;
a reactor for inducing a reduction reaction of exhaust gas mixed with the reducing agent and decomposing nitrogen oxide in the exhaust gas to nitrogen and water vapor to reduce the nitrogen oxide,
wherein the reducing agent inlet is configured in such a way that the injecting module, the pump, and the pressure transmitter are formed as a module in an integrated dosing unit (IDU) that is one physical space.

2. The exhaust gas vessel denitration system of claim 1, wherein the injecting module includes:
a chamber in which an outlet connected to the exhaust pipe and urea is sprayed from the injector; and
a compressed air heating supply device for heating compressed air and introducing the compressed heated air into the chamber,
wherein the urea is mixed with the compressed heated air in the chamber and is changed to ammonia.

3. The exhaust gas vessel denitration system of claim 2, wherein the compressed air heating supply device includes:
a compressed air inlet for injecting the compressed air;
a compressed air transfer pipe for transferring the compressed air injected through the compressed air inlet and introducing the compressed air into the chamber; and
a heating unit for heating the compressed air inside the compressed air transfer pipe.

4. The exhaust gas vessel denitration system of claim 3, wherein the compressed air transfer pipe includes:
a cooling part that is a section disposed adjacently to the injector and cools the injector by the compressed air prior to heating; and
a heating part that is disposed adjacent to the heating unit next to the cooling part to heat and transfer the compressed air transmitted through the cooling part and to introduce the compressed air into the chamber.

5. The exhaust gas vessel denitration system of claim 4, wherein the cooling part is formed to surround the injector.

6. The exhaust gas vessel denitration system of claim 4, wherein the heating unit is a heater disposed inside or outside the heating part.

7. The exhaust gas vessel denitration system of claim 1, wherein the reactor includes:
a catalyst for inducing a reduction reaction of exhaust gas mixed with ammonia; and
a reactor with the catalyst positioned therein.

8. The exhaust gas vessel denitration system of claim 7, wherein the catalyst includes:
a support formed of metal with a surface on which a titanium oxide (TiO₂) nanotube is formed; and
a reactive metal layer including one or more of vanadium (V) and tungsten (W) and supported on the support.

9. The exhaust gas vessel denitration system of claim 8, wherein the support is formed of the metal that is titanium (Ti).

10. The exhaust gas vessel denitration system of claim 9, wherein the titanium oxide (TiO₂) nanotube has a diameter of 100 to 200 nm and a length of 300 nm to 1 μm.

11. The exhaust gas vessel denitration system of claim 10, wherein the support has a thickness of 0.1 to 0.15 mm.

12. The exhaust gas vessel denitration system of claim 9, wherein the support is changed to an anatase phase via thermal treatment.

13. The exhaust gas vessel denitration system of claim 12, wherein the reactive metal layer is supported on the support using an atomic layer deposition (ALD) method.

14. A method of determining nozzle clogging in an exhaust gas vessel denitration system, the method comprising:
a) pre-drive operation for generating and maintaining appropriate pressure prior to an engine operation and urea spray;
b) operation of determining whether an exhaust gas temperature condition for enabling SCR is satisfied;
c) operation of selecting an urea dosing amount depending on a current engine load by a controller;
d) operation of controlling opening and closing of an injector value to perform spray under PWM control;
e) operation of controlling a rotation number of a dosing pump to maintain pressure of normal driving; and
f) operation of checking a relationship between an urea spray amount and a pump rotation number.
